(19) United States
(12) Patent Application Publication
(10) Pub. No.: US 2009/0094104 A1
(43) Pub. Date: Apr. 9, 2009

(54) Advertisements for Products in Media Content

(75) Inventor: Ahmad Nizam Anuar, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/867,685

(22) Filed: Oct. 4, 2007

(51) Int. Cl. G06Q 30/00; G06F 17/40; G06F 19/00

(52) U.S. Cl. 705/14

(57) ABSTRACT

Advertisements for products in media content is described. In embodiment(s), products that are included in video media content can be determined. A request for the video media content can be received, such as to purchase the video media content and/or as an on-demand request from a television client device. Advertisements can then be displayed for the products that are included in the video media content, and a product can be selected for purchase from an advertisement.

### BACKGROUND

Various companies, manufacturers, and marketers negotiate to have their products included in movies and television programs in an effort to showcase the products to a large audience and to those that may be likely to purchase the products. The products may include any items such as the music for a movie, cars, clothes, sunglasses, vacation destinations, furniture used on a movie set, consumable products, and the like. However, a viewer that may be interested in a particular style of sunglasses worn by an actor in a movie may have to research or investigate to determine the brand and model of the sunglasses because the information needed to purchase the product may not be apparent when simply watching the movie.

### SUMMARY

This summary is provided to introduce simplified concepts of advertisements for products in media content. The simplified concepts are further described below in the Detailed Description. This summary is not intended to identify essential features of the claimed subject matter, nor is it intended for use in determining the scope of the claimed subject matter.

In embodiment(s), products that are included in video media content can be determined. A request for the video media content can be received, such as to purchase the video media content and/or as an on-demand request from a television client device. Advertisements can then be displayed for the products that are included in the video media content, and a product can be selected for purchase from an advertisement.

In other embodiment(s), an advertisement service can determine products that are included in a video, such as by evaluating metadata associated with the video. The advertisement service can also maintain advertisements of the products for distribution when a video is selected for purchase, searched for, and/or selected as an on-demand viewing request, such as from a media content vendor and/or from a media content distributor. A viewer can then select a product that is associated with a video for purchase from an advertisement for the product.

### BRIEF DESCRIPTION OF THE DRAWINGS

Embodiments of advertisements for products in media content are described with reference to the following drawings. The same numbers are used throughout the drawings to reference like features and components:

FIG. 1 illustrates an example system in which embodiments of advertisements for products in media content can be implemented.

FIG. 2 illustrates another example system in which embodiments of advertisements for products in media content can be implemented.

FIG. 3 illustrates example method(s) for embodiments of advertisements for products in media content.

FIG. 4 illustrates example method(s) for embodiments of advertisements for products in media content.

FIG. 5 illustrates various components of an example device which can implement embodiments of advertisements for products in media content.

FIG. 6 illustrates various devices and components in an example entertainment and information system in which embodiments of advertisements for products in media content can be implemented.

### DETAILED DESCRIPTION

Embodiments of advertisements for products in media content provide that products which are placed or positioned by marketers and manufacturers in movies and/or television programs to attract consumers are then targeted to those that may be likely to purchase the products. An advertisement service can be implemented to determine products that are included in video media content, such as a movie, by evaluating metadata associated with the video. The advertisement service can also maintain advertisements of the products for distribution when the video is selected for purchase, searched for, and/or selected as an on-demand viewing request, such as from a media content vendor and/or from a media content distributor. A viewer can then select a product that is associated with a video for purchase from an advertisement for the product.

While features and concepts of the described systems and methods for embodiments of advertisements for products in media content can be implemented in any number of different environments, systems, and/or various configurations, embodiments of advertisements for products in media content are described in the context of the following example systems and environments.

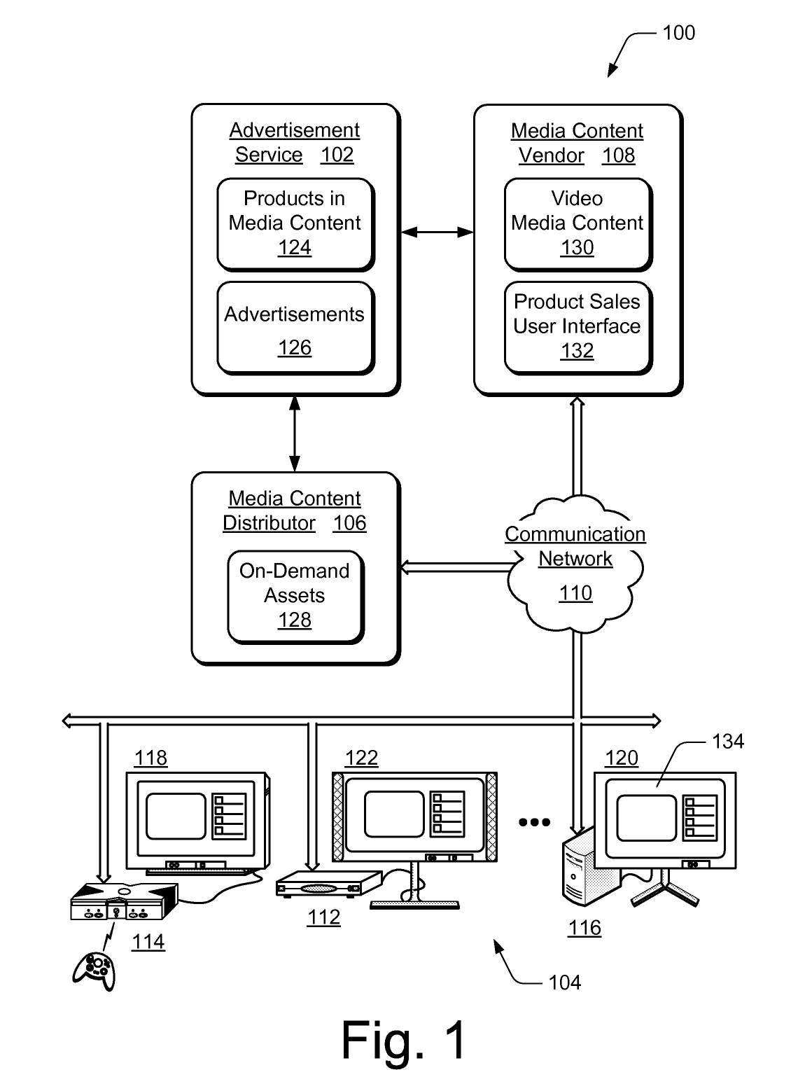

FIG. 1 illustrates an example system 100 in which various embodiments of advertisements for products in media content can be implemented. In this example, system 100 includes an advertisement service 102 and various client systems 104 that can each receive media content from a media content distributor 106 and/or a media content vendor 108 via a communication network 110. The client systems 104 each include a client device and a respective display device that together render audio, video, and/or image data.

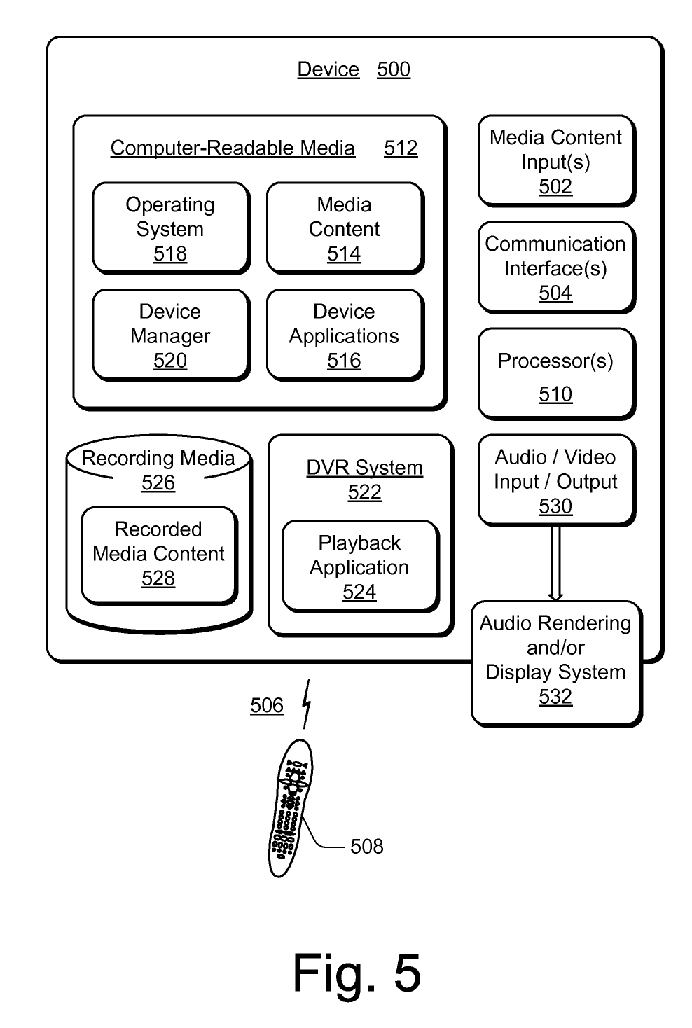

A client device of a client system 104 can be implemented as any one or combination of a television client device 112, a digital video recorder (DVR) and playback system, an appliance device, a gaming console 114, a portable communication device, a portable computing device, and/or as any other type of television client device or computer device 116. Additionally, any of the client devices can be implemented with any number and combination of differing components as further described with reference to the example device shown in FIG. 5. A client device may also be associated with a user or viewer (i.e., a person) and/or an entity that operates the device such that a client device describes logical clients that include users, software, and/or devices.

The respective display devices of the client systems 104 can be implemented as any type of television 118, LCD 120, or similar display system or device 122 to display television and/or video media content, as well as advertisements for products that are included in various media content. The client devices are configured for communication via the communication network 110 that facilitates media content distribution and data communication between any number of the client devices, various media content vendor(s), and/or media content distributor(s). The communication network 110 can be implemented to include an IP-based network and/or as a broadcast network, as part of a media content distribution system using any type of network topology and/or communication protocol, and can be represented or otherwise implemented as a combination of two or more networks.

The advertisement service 102 can be implemented to determine products in media content 124 (e.g., products that are included in media content), such as products included in videos (e.g., movies, on-demand movies, movies on DVD, television programs, and the like). In an embodiment, the advertisement service 102 can evaluate metadata associated with various media content, such as videos, to determine products that are included in the media content. For example, a movie or television program may include products positioned by various manufacturers and/or marketers to showcase and attract consumers, such as cars, clothes, sunglasses, music, vacation destinations, and any other type of products and/or services. The advertisement service 102 can also maintain advertisements 126 (e.g., advertisement data) that corresponds to each of the products determined to be included in video media content.

In an embodiment, the advertisement service 102 can also be implemented to generate a recommendation of other media content that include similar products which are determined to be included in video media content. The advertisement service 102 can receive a selection of a product in an advertisement and initiate delivery of additional video media content that also includes the selected product. For example, a viewer may be interested in a furniture item that is included in a television program. The advertisement service 102 can then provide a list of other programs or media content that also include the furniture item so that the viewer may see other views and/or options of the furniture item from which to make a better purchase decision.

As described throughout, “media content” can include television programs (or programming) which may be any form or combination of programs, commercials, music, movies, videos, and on-demand media content. Other media content can include interactive games, network-based applications, and any other audio, video, and/or image content (e.g., to include program guide application data, user interface data, search results and/or recommendations, and the like). In a gaming environment, a ‘product’ may include a user's character or stage that can be advertised for purchase to facilitate a purchaser being able to complete a particular stage or level of a game. Other advertisements may be offers for services or other products that help users complete game stages or levels.

The media content distributor 106 can be implemented as a network television program distributor, a cable operator, and the like to distribute media content, program and advertising content, music, and any other audio, video, and/or image content to the client systems 104. In this example, the media content distributor 106 stores and/or maintains on-demand assets 128, such as on-demand movies (e.g., video media content), that can be requested by the various client devices of the client systems 104. For example, the media content distributor 106 can receive an on-demand viewing request for video media content from television client device 112. The media content distributor 106 can then initiate delivery of an on-demand asset 128 to distribute the video media content to the requesting client device 112 that renders the video for viewing.

The media content distributor 106 can distribute the on-demand assets 128 to any number of the client devices via the communication network 110 which can include an IP-based network. The communication network 110 facilitates media content distribution and data communication between media content distributor(s), media content vendor(s), and/or any number of client devices. The communication network 110 can be implemented as part of a media content distribution system using any type of network topology and/or communication protocol, and can be represented or otherwise implemented as a combination of two or more networks.

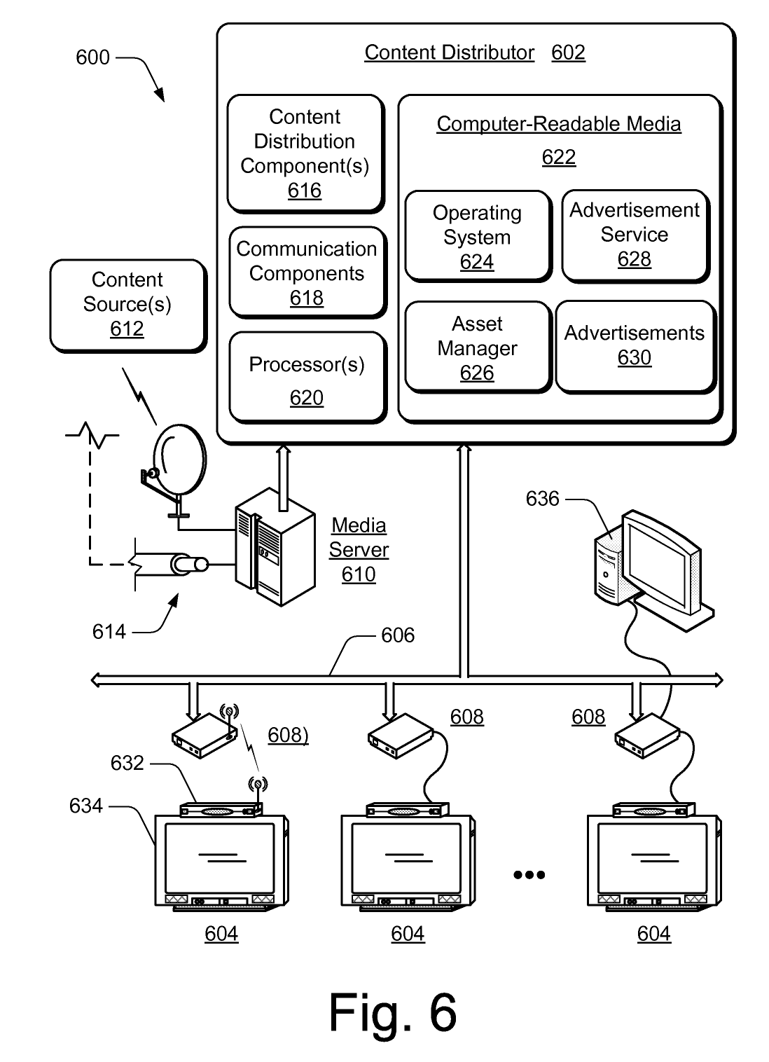

In addition to the on-demand assets 128, the media content distributor 106 can be implemented with any number and combination of differing components as further described with reference to the example device shown in FIG. 5 and/or the example content distributor shown in FIG. 6. Although the advertisement service 102 is illustrated and described as an independent component of the example system 100, the media content distributor 106 and/or the media content vendor 108 can include the advertisement service 102 to implement various embodiments of advertisements for products in media content.

The media content vendor 108 can be implemented as an Internet-based, retail Web site through which a user can purchase video media content 130, such as movies on DVD, or other music content, gaming applications, and the like. The media content vendor 108 and/or the media content distributor 106 may also include a Web site through which a user can search, select, and/or watch videos, such as videos uploaded by other users that intend to distribute and make the videos available for viewing. In an embodiment, a user that uploads a video for others to view can also provide the advertisements for products in the video, music associated with the video, a music CD or DVD of the video itself, and the like.

In this example, the media content vendor 108 has the video media content 130 for viewing and/or purchase, and includes a product sales user interface 132. The media content vendor 108 can receive a search and/or purchase request for video media content from computer device 116, or a request for an on-line gaming session from gaming console 114. The media content vendor 108 can then initiate a display 134 of the product sales user interface 132 which can include advertisements 126 for products in media content 124 obtained from the advertisement service 102.

A product that is included in the video media content 130 and shown in an advertisement can be selected for purchase from the product sales user interface, such as when displayed on display devices of the client systems 104. In an embodiment, a user interface that is initiated to display product advertisements may also include preferred vendors from which the products that are included in the video media content can be selected for purchase.

The advertisement service 102 can be implemented to determine the products that are included in the on-demand assets 128 at the media content distributor 106 and/or determine the products that are included in the video media content 130 at the media content vendor 108. The advertisements 126 for the products in the media content 124 can then be included in a display along with video media content that has been searched for, requested, purchased, ordered, and the like. This provides that products which are placed or positioned by marketers and manufacturers in movies, television programs, or other video media content to attract consumers are then targeted to those that may likely have an interest in purchasing the products.

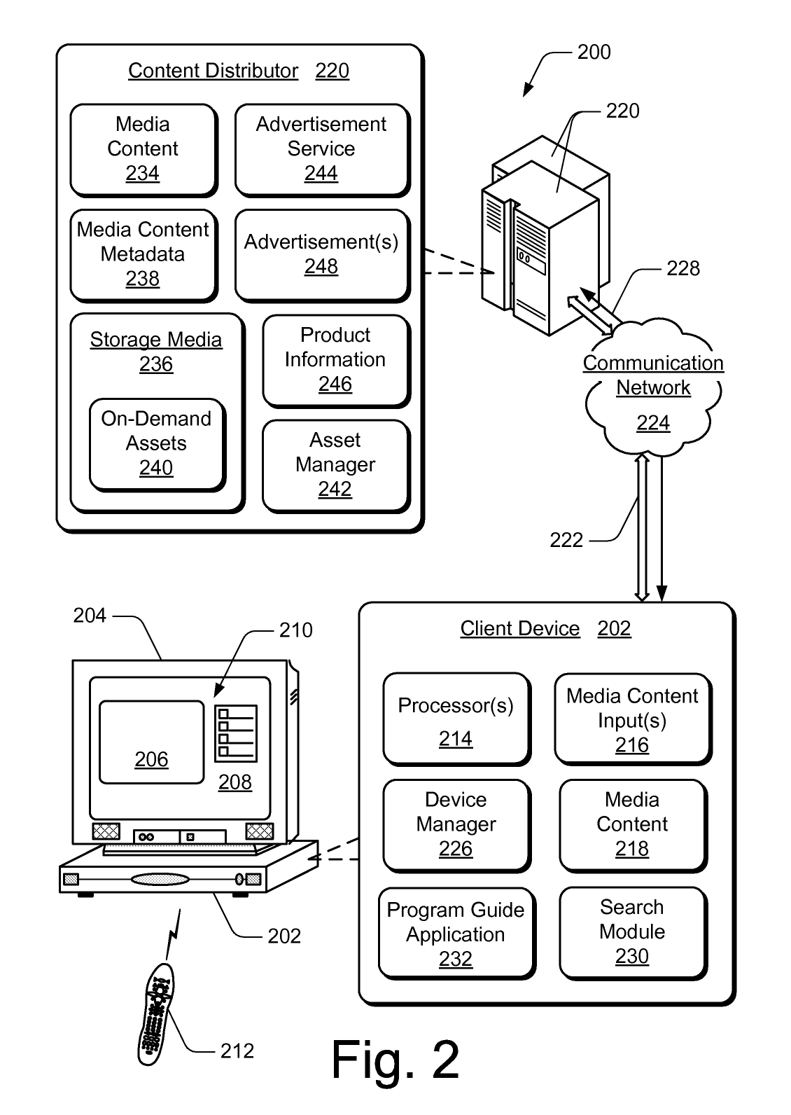

FIG. 2 illustrates an example system 200 in which various embodiments of advertisements for products in media content can be implemented. In this example, system 200 includes a client device 202 and a display device 204 that can display video media content 206 and/or advertisements 208 for products included in the video media content on a user interface 210. The client device 202 and display device 204 together are an example of a television client system that renders audio, video, and/or image data. The display device 204 can be implemented as any type of television, LCD, or similar display system to display video media content 206 and the associated advertisements 208. A viewer can interact with the client device 202 and initiate selections of products from the advertisements 208 on the user interface 210 with user inputs via an input device 212, such as a television remote control.

The example client device 202 can be implemented as any one or combination of a television set-top box, a digital video recorder (DVR) and playback system, an appliance device, a gaming console, a portable communication device, a portable computing device, and/or as any other type of television client device or computing-based device that may be implemented in a television entertainment and information system. Additionally, client device 202 can be implemented with any number and combination of differing components as further described with reference to the example device shown in FIG. 5. Client device 202 may also be associated with a user or viewer (i.e., a person) and/or an entity that operates the device such that a client device describes logical clients that include users, software, and/or devices.

In the example system 200, client device 202 includes one or more processors 214 (e.g., any of microprocessors, controllers, and the like), media content inputs 216, and media content 218 (e.g., received media content, media content that is being received, advertisements for products in media content, etc.). The client device 202 can be configured for communication with various content distributor(s) 220 via an IP-based network 222 and/or communication network 224. The media content inputs 216 can include any type of communication interfaces and/or data inputs, such as Internet Protocol (IP) inputs over which streams of video media content and/or television media content (e.g., IPTV media content, music media content, etc.) are received via the IP-based network 222 and/or communication network 224. The media content inputs 216 can include any type of wireless, broadcast, and/or over-the-air inputs via which media content is received.

The IP-based network 222 can be implemented as part of the communication network 224 that facilitates media content distribution and data communication between the content distributor(s) 220 and any number of client devices, such as client device 202. The communication network 224 can be implemented as part of a media content distribution system using any type of network topology and/or communication protocol, and can be represented or otherwise implemented as a combination of two or more networks.

Client device 202 also includes a device manager 226 (e.g., a control application, software application, etc.) that can be implemented as computer-executable instructions and executed by the processor(s) 214 to implement various embodiments of advertisements for products in media content. The device manager 226 can be implemented to monitor and/or receive user-initiated inputs (e.g., user selections) via the input device 212, and initiate communication of the user inputs back to a content distributor 220.

The client device 202 can communicate user inputs and other data to a content distributor 220 via a two-way data communication link 228 of the communication network 224. It is contemplated that any one or more of the arrowed communication link 228 and network 222, along with communication network 224, facilitate two-way data communication, such as from client device 202 to a content distributor 220 and vice-versa.

The client device 202 can also include a search module 230 and a program guide application 232, both of which can be implemented as computer-executable instructions and executed by the processor(s) 214 to implement embodiments of advertisements for products in media content. In an embodiment, the search module 230 can receive a viewer-initiated search request for video media content via the input device 212. The program guide application 232 can be implemented to process program guide data from which a program guide can be rendered and/or displayed for viewing on display device 204. A program guide may also be commonly referred to as an electronic program guide or an “EPG”. In this example, the user interface 210 that includes the advertisements 208 for products included in video media content may be rendered as a panel of a program guide search interface.

A content distributor 220 can distribute media content 234 (e.g., video media content such as movies, on-demand movies, movies on DVD, television programs, and the like) to any number of television client devices as an IPTV multicast via the IP-based network 222 and/or the communication network 224. The content distributor 220 can also include various components to implement various embodiments of advertisements for products in media content.

In this example system 200, content distributor 220 includes storage media 236 to store or maintain the media content 234, media content metadata 238, and/or on-demand assets 240 that can be requested by various television client devices. The content distributor 220 also includes an asset manager 242 to manage the assets maintained by the content distributor, such as the media content 234 and the on-demand assets 240. In addition, a content distributor 220 can be implemented with any number and combination of differing components as further described with reference to the example device shown in FIG. 5 and/or the example content distributor shown in FIG. 6.

The content distributor 220 can also include an advertisement service 244 to implement various embodiments of advertisements for products in media content. An example of the advertisement service 244 is described with reference to the advertisement service 102 in example system 100. In various embodiments, the advertisement service 244 can be implemented to generate product information 246 for products that are determined to be included in the media content 234 and/or the on-demand assets 240. In various embodiments, the product information 246 can be generated by data entry, by the advertisement service 244, from closed caption data, from the media content metadata 238, and/or by any other system implemented to generate product information for products included in media content. The content distributor 220 can then maintain advertisements 248 that correspond to the product information 246.

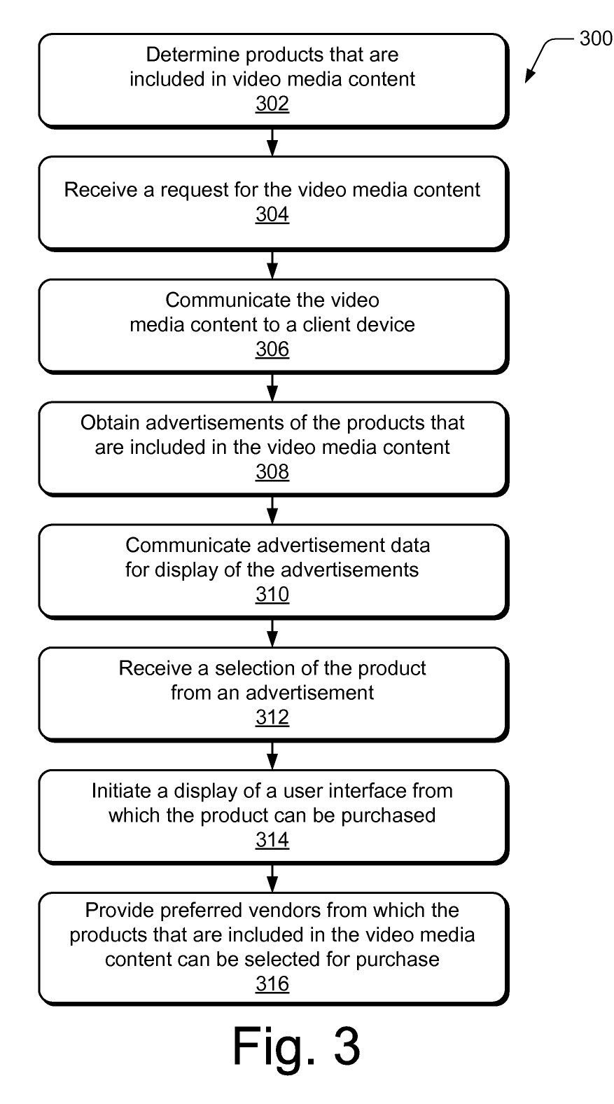

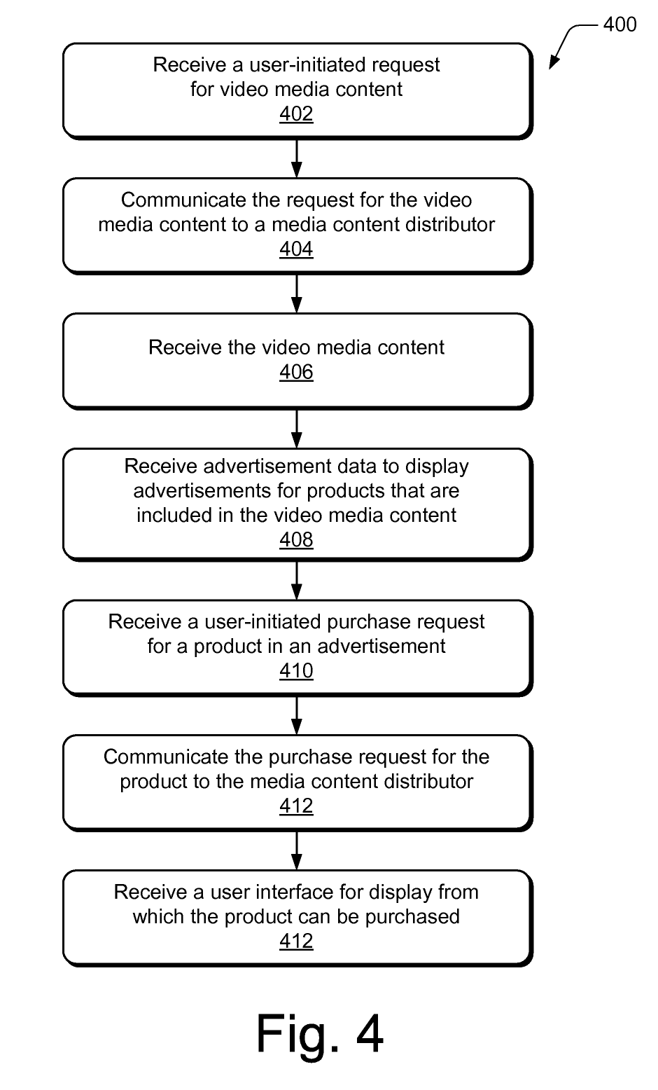

Generally, any of the functions, methods, procedures, and modules described herein can be implemented using hardware, software, firmware (e.g., fixed logic circuitry), manual processing, or any combination thereof. A software implementation of a function, method, procedure, or module represents program code that performs specified tasks when executed on a computing-based processor. Example methods 300 and 400 described with reference to respective FIGS. 3 and 4 may be described in the general context of computer-executable instructions. Generally, computer-executable instructions can include applications, routines, programs, objects, components, data structures, procedures, modules, functions, and the like that perform particular functions or implement abstract data types.

The method(s) may also be practiced in a distributed computing environment where functions are performed by remote processing devices that are linked through a communications network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 3 illustrates example method(s) 300 for various embodiments of advertisements for products in media content. The order in which the method is described is not intended to be construed as a limitation, and any number of the described method blocks can be combined in any order to implement the method, or an alternate method.

At block 302, products are determined that are included in video media content. For example, the advertisement service 102 (FIG. 1) determines products in media content 124 (e.g., products that are included in media content), such as products included in videos (e.g., movies, on-demand movies, movies on DVD, television programs, and the like). In an embodiment, the advertisement service 102 evaluates metadata 238 associated with various media content 234 and/or on-demand assets 240, such as videos, to determine products that are included in the media content.

At block 304, a request for the video media content is received. For example, the media content distributor 106 receives an on-demand viewing request for video media content from television client device 112. In another example, the media content vendor 108 receives a search and/or purchase request for video media content from computer device 116, or a request for an on-line gaming session from gaming console 114.

At block 306, the video media content is communicated to a client device. For example, the media content distributor 106 initiates delivery of an on-demand asset 128 to distribute the video media content to the requesting client device 112 that renders the video for viewing. In another example, the media content vendor 108 can initiate delivery of video media content 130 as a video, a search result displayed in a program guide, as a selectable image or graphic representation of the video, and/or as other video media content.

At block 308, advertisements of the products that are included in the video media content are obtained. For example, the advertisement service 102 determines the products that are included in the on-demand assets 128 at the media content distributor 106 and/or determines the products that are included in the video media content 130 at the media content vendor 108. The media content distributor 106 and/or the media content vendor 108 then obtains the advertisements 126 for the products in the media content 124.

At block 310, advertisement data is communicated for display of the advertisements. For example, the media content distributor 106 communicates advertisement data to the television client device 112 that renders the advertisements for display to a viewer. In another example, the media content vendor 108 communicates advertisement data to the computer device 116 that renders the advertisements for display to a user.

At block 312, a selection of the product selected from an advertisement is received. For example, a viewer or user at a client system 104 can select a product that is included in a video for purchase from an advertisement that is displayed at a client system 104, and the media content distributor 106 and/or the media content vendor 108 receives the user selection.

At block 314, a display of a user interface from which the product can be purchased is initiated, and at block 316, preferred vendors are provided from which the products that are included in the video can be selected for purchase. For example, the media content vendor 108 initiates a display 134 of the product sales user interface 132 which includes advertisements 126 obtained from the advertisement service 102 for products included in the media content 124. In an embodiment, a user interface that is initiated to display product advertisements also includes preferred vendors from which the products that are included in the video media content can be selected for purchase.

FIG. 4 illustrates example method(s) 400 for various embodiments of advertisements for products in media content. The order in which the method is described is not intended to be construed as a limitation, and any number of the described method blocks can be combined in any order to implement the method, or an alternate method.

At block 402, a user-initiated request for video media content is received. For example, a client device of a client system 104 receives a user selection for video media content as a search request, a purchase request, and/or as an on-demand viewing request. A viewer can initiate selections and commands with user inputs via the television remote control input device 212. For example, a viewer at the television client device 112 can initiate an on-demand viewing request for an on-demand asset 128 from media content distributor 106. Additionally, a user at computer device 116 can initiate a search and/or purchase request for video media content from either the media content distributor 106 or the media content vendor 108.

At block 404, the request for the video media content is communicated to a media content distributor, and at block 406, the video media content is received. For example, a client device of a client system 104 receives the user-initiated request and communicates the request to the media content distributor 106 and/or to the media content vendor 108. The television client device 112 then receives the requested video media content from the media content distributor 106 as an on-demand movie for viewing. In another example, the computer device 116 receives an image or graphic representation of the requested video media content (such as on a Web page) from which the video media content can be selected for purchase.

At block 408, advertisement data is received to display advertisements for products that are included in the video media content. For example, a client device of a client system 104 receives advertisements 126 for products in the media content 124 when the video media content is searched for, requested, purchased, ordered, and the like.

At block 410, a user-initiated request for a product in an advertisement is received, and at block 412, the request for the product is communicated to the media content distributor. For example, a client device of a client system 104 receives a user selection to initiate a purchase of a product in an advertisement, and the client device communicates the user purchase request to the media content distributor 106 and/or to the media content vendor 108.

At block 414, a user interface is received for display from which the product can be purchased. For example, the client device of a client system 104 receives the product sales user interface 132 from the media content vendor 108 and the product sales user interface includes advertisements 126 for products included in the media content 124.

FIG. 5 illustrates various components of an example device 500 that can be implemented as any form of a computing, electronic, appliance, television client device, or television system device to implement various embodiments of advertisements for products in media content. For example, device 500 can be implemented as a client device in a client system as shown in FIG. 1, and/or as the television client device or content distributor shown in FIG. 2. In various embodiments, device 500 can be implemented as any one or combination of a television client device, a digital video recorder (DVR), a gaming system or console, a computing-based device, an appliance device, and/or as any other type of similar device.

Device 500 includes one or more media content inputs 502 that may include Internet Protocol (IP) inputs over which streams of media content are received via an IP-based network. Device 500 further includes communication interface(s) 504 that can be implemented as any one or more of a serial and/or parallel interface, a wireless interface, any type of network interface, a modem, and as any other type of communication interface. A network interface provides a connection between device 500 and a communication network by which other electronic and computing devices can communicate data with device 500.

Similarly, a serial and/or parallel interface provides for data communication directly between device 500 and the other electronic or computing devices, such as via an Ethernet connection. A modem also facilitates communication with other electronic and computing devices via a conventional telephone line, a DSL connection, cable, and/or other type of connection. A wireless interface enables device 500 to receive control input commands 506 and other data from an input device, such as from remote control device 508, a portable computing-based device (such as a cellular phone), or from another infrared (IR), 802.11, Bluetooth, or similar RF input device.

Device 500 also includes one or more processors 510 (e.g., any of microprocessors, controllers, and the like) which process various computer-executable instructions to control the operation of device 500, to communicate with other electronic and computing devices, and to implement embodiments of a advertisements for products in media content. Device 500 can be implemented with computer-readable media 512, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like.

Computer-readable media 512 provides data storage mechanisms to store media content 514, as well as device applications 516 and any other types of information and/or data related to operational aspects of device 500. For example, an operating system 518 can be maintained as a computer application with the computer-readable media 512 and executed on processor(s) 510. The device applications can include a device manager 520 which is shown as a software module in this example. An example of the device manager 520 is described with reference to device manager 226 for client device 202 shown in FIG. 2.

When implemented as a television client device, the device 500 can also include a DVR system 522 with a playback application 524, and recording media 526 to maintain recorded media content 528 that device 500 receives and/or records. The recorded media content 528 can include the media content 514 that is received from a content distributor and recorded. For example, the media content 528 can be recorded when received as a viewer-scheduled recording, or when the recording media 526 is implemented as a pause buffer that records the media content 528 as it is being received and rendered for viewing.

Further, device 500 may access or receive additional recorded media content that is maintained with a remote data store (not shown). Device 500 may also receive media content from a video-on-demand server, or media content that is maintained at a broadcast center or content distributor that distributes the media content to subscriber sites and client devices. The playback application 524 can be implemented as a media control application to control the playback of media content 514, the recorded media content 528, and/or any other audio, video, and/or image media content which can be rendered and/or displayed for viewing.

Device 500 also includes an audio and/or video output 530 that provides audio and/or video data to an audio rendering and/or display system 532. The audio rendering and/or display system 532 can include any devices that process, display, and/or otherwise render audio, video, and image data. Video signals and audio signals can be communicated from device 500 to a display device via an RF (radio frequency) link, S-video link, composite video link, component video link, DVI (digital video interface), analog audio connection, or other similar communication link. Alternatively, the audio rendering and/or display system 532 can be implemented as integrated components of the example device 500.

FIG. 6 illustrates an example entertainment and information system 600 in which various embodiments of advertisements for products in media content can be implemented. System 600 facilitates the distribution of media content, program guide data, and/or advertising content to multiple viewers and viewing systems. System 600 includes a content distributor 602 and any number of client systems 604 each configured for communication via a communication network 606. Each of the client systems 604 can receive data streams of media content, program content, program guide data, advertising content, closed captions data, event metadata, and the like from content server(s) of the content distributor 602 via the communication network 606.

The communication network 606 can be implemented as any one or combination of a wide area network (e.g., the Internet), a local area network (LAN), an intranet, an IP-based network, a broadcast network, a wireless network, a Digital Subscriber Line (DSL) network infrastructure, a point-to-point coupling infrastructure, or as any other media content distribution network. Additionally, communication network 606 can be implemented using any type of network topology and any network communication protocol, and can be represented or otherwise implemented as a combination of two or more networks. A digital network can include various hardwired and/or wireless links 608, such as routers, gateways, and so on to facilitate communication between content distributor 602 and the client systems 604.

System 600 includes a media server 610 that receives content from various content sources 612, such as media content from a content provider, program guide data from a program guide source, and advertising content from an advertisement provider. In an embodiment, the media server 610 represents an acquisition server that receives audio and video content from a provider, an EPG server that receives the program guide data from a program guide source, and/or an advertising management server that receives the advertising content from an advertisement provider.

The content sources, such as the content provider, program guide source, and the advertisement provider control distribution of the media content, the program guide data, and the advertising content to the media server 610 and/or to other servers of system 600. The media content, program guide data, and advertising content can be distributed via various transmission media 614, such as satellite transmission, radio frequency transmission, cable transmission, and/or via any number of other wired or wireless transmission media. In this example, media server 610 is shown as an independent component of system 600 that communicates the program content, program guide data, and advertising content to content distributor 602. In an alternate implementation, media server 610 can be implemented as a component of content distributor 602.

Content distributor 602 is representative of a headend service in a content distribution system, for example, that provides the media content, program guide data, and advertising content to multiple subscribers (e.g., the client systems 604). The content distributor 602 can be implemented as a satellite operator, a network television operator, a cable operator, an Internet-based content distributor, and the like to control distribution of media content, program and advertising content, movies, television programs, commercials, music, and any other audio, video, and/or image content to the client systems 604.

Content distributor 602 includes various content distribution components 616 to facilitate media content processing and distribution, such as a subscriber manager, a device monitor, and one or more content servers. The subscriber manager manages subscriber data, and the device monitor monitors the client systems 604 (e.g., and the subscribers), and maintains monitored client state information.

Although the various managers, servers, and monitors of content distributor 602 (to include the media server 610 in one embodiment) are described as distributed, independent components of content distributor 602, any one or more of the managers, servers, and monitors can be implemented together as a multi-functional component of content distributor 602. Additionally, any one or more of the managers, servers, and monitors described with reference to system 600 can implement features and embodiments of advertisements for products in media content.

In this example, the content distributor 602 includes communication components 618 that can be implemented to facilitate media content distribution to the client systems 604 via the communication network 606. The content distributor 602 also includes one or more processors 620 (e.g., any of microprocessors, controllers, and the like) which process various computer-executable instructions to control the operation of content distributor 602. The content distributor 602 can be implemented with computer-readable media 622 which provides data storage to maintain software applications such as an operating system 624, an asset manager 626, and an advertisement service 628. The computer-readable media 622 can also provide data storage to maintain advertisements 630 that correspond to various products included in media content.

The client systems 604 can each be implemented to include a client device 632 and a display device 634 (e.g., a television, LCD, and the like). A client device 632 of a respective client system 604 can be implemented in any number of embodiments, such as a set-top box, a digital video recorder (DVR) and playback system, an appliance device, a gaming system, and as any other type of client device that may be implemented in an entertainment and information system. In an alternate embodiment, a client system 604 may implemented with a computing device 636 as well as a client device. Additionally, any of the client devices 632 of a client system 604 can implement features and embodiments of advertisements for products in media content as described herein.

Although embodiments of advertisements for products in media content have been described in language specific to features and/or methods, it is to be understood that the subject of the appended claims is not necessarily limited to the specific features or methods described. Rather, the specific features and methods are disclosed as example implementations of advertisements for products in media content.

1. A method, comprising:
determining products that are included in a video;
receiving a request for the video; and
displaying advertisements for the products from which a product that is included in the video can be selected for purchase.

2. A method as recited in claim 1, wherein the request for the video is received as a selection to purchase the video, and wherein the product can be selected for purchase along with the video.

3. A method as recited in claim 1, wherein the request for the video is received as an on-demand request, and the method further comprises:
communicating the video to a client device that renders the video for viewing; and
communicating advertisement data for the advertisements to the client device that renders the advertisements for display.

4. A method as recited in claim 1, further comprising receiving a selection of the product from an advertisement and initiating a display of a user interface from which the product can be purchased.

5. A method as recited in claim 1, further comprising:
receiving a search request for the video from a client device;
communicating image data for an image that is representative of the video to the client device for display of the image; and
communicating advertisement data for the advertisement to the client device for display of the advertisement.

6. A method as recited in claim 1, further comprising evaluating metadata associated with media content of the video to determine the products that are included in the video.

7. A method as recited in claim 1, further comprising providing preferred vendors for display from which the products that are included in the video can be selected for purchase.

8. A media content distributor, comprising:
an advertisement service configured to determine products that are included in video media content;
a media content server configured to:
receive a request for the video media content from a client device;
initiate delivery of the video media content; and
communicate advertisement data for advertisements of the products that are included in the video media content to the client device such that a product can be selected for purchase.

9. A media content distributor as recited in claim 8, wherein the request for the video media content is received as a selection to purchase the video media content, and wherein the product can be selected for purchase along with the video media content.

10. A media content distributor as recited in claim 8, wherein the request for the video media content is received as a request for an on-demand video, and wherein the media content server is further configured to initiate delivery of the on-demand video to the client device that renders the on-demand video for viewing.

11. A media content distributor as recited in claim 8, wherein the advertisement service is further configured to receive a selection of the product in an advertisement, and the media content server is further configured to initiate delivery of additional video media content that also includes the product.

12. A media content distributor as recited in claim 8, wherein the advertisement service is further configured to evaluate metadata associated with video media content to determine the products that are included in the video media content.

13. A media content distributor as recited in claim 8, wherein the advertisement service is further configured to provide preferred vendors from which the products that are included in the video media content can be selected for purchase.

14. One or more computer-readable media comprising computer-executable instructions that, when executed, direct a media content distributor to:
receive a request for the video media content from a client device;
initiate delivery of the video media content to the client device;
obtain advertisements for products that are included in the video media content; and
communicate advertisement data for the advertisements of the products to the client device such that a product can be selected for purchase.

15. One or more computer-readable media as recited in claim 14, further comprising computer-executable instructions that, when executed, direct the media content distributor to receive the request for the video media content as a selection to purchase the video media content, and wherein the product can be selected for purchase along with the video media content.

16. One or more computer-readable media as recited in claim 14, further comprising computer-executable instructions that, when executed, direct the media content distributor to receive the request for the video media content as a request for an on-demand video, and to initiate delivery of the on-demand video to the client device.

17. One or more computer-readable media as recited in claim 14, further comprising computer-executable instructions that, when executed, direct the media content distributor to receive the request for the video media content as a search request from the client device, and to communicate image data for an image of the video media content to the client device for display of the image of the video media content.

18. One or more computer-readable media as recited in claim 14, further comprising computer-executable instructions that, when executed, direct the media content distributor to receive a selection of the product from an advertisement and initiate a display of a user interface from which the product can be purchased.

19. One or more computer-readable media as recited in claim 14, further comprising computer-executable instructions that, when executed, direct the media content distributor to evaluate metadata associated with video media content to determine the products that are included in the video media content.

20. One or more computer-readable media as recited in claim 14, further comprising computer-executable instructions that, when executed, direct the media content distributor to provide preferred vendors from which the products that are included in the video media content can be selected for purchase.
